(19) United States
(12) Patent Application Publication
(10) Pub. No.: US 2021/0214261 A1
(43) Pub. Date: Jul. 15, 2021

(54) GLASS PRODUCT FORMING MOLD, GLASS PRODUCT FORMING DEVICE, AND METHOD OF PROCESSING GLASS PRODUCT

(71) Applicant: AAC Optics Solutions Pte. Ltd., Singapore City (SG)

(72) Inventors: Thomas Aabo, Albertslund (DK); Jacob Kibsgaard Kjær, Soborg (DK); Peter Krohne Nielsen, Hillerod (DK); Simon Bo Jensen, Hillerod (DK); Michal Sobol, Kobenhavn (PL); Tsz Lok Keith Tang, Hong Kong (CN); Niels Christian Roemer Holme, Farum (DK); Bingke Zhu, Shenzhen (CN)

(21) Appl. No.: 16/809,598

(22) Filed: Mar. 5, 2020

(30) Foreign Application Priority Data
Jan. 9, 2020 (CN) 202010023212.7

(51) Int. Cl. C03B 11/08; C03B 23/03

(52) U.S. Cl. CPC C03B 11/08; C03B 23/0302

(57) ABSTRACT

A glass product forming mold includes a mold body and a plurality of sliding blocks slidably mounted on the mold body and facing the glass product; each of the plurality of sliding blocks includes a first inclined surface; the plurality of sliding blocks are configured to be inserted between the glass product and the mold body through the plurality of the first inclined surfaces to separate the glass product from the mold body. The sliding blocks are driven to separate the glass product from the mold body, avoiding the deformation of raw glass products resulting from the uneven heat distribution, uneven shrinkage or excessive adhesion, and the glass products will not be interfered by the mold body during the process of cooling shrinkage, which reduces the risk of cracking of the glass product.

### TECHNICAL FIELD

The disclosure relates to formations of glass products, and more particularly to a mold and device of forming a glass product, and a method of processing the glass product.

### BACKGROUND

Lenses are optical elements made of transparent materials (such as glass, crystal, etc.), which can be widely used in security, vehicle, digital camera, laser, optical instruments, and other fields. With the continuous expansion of the market, the application of lens is more and more extensive. Especially with the development of the Internet, various electronic devices are brought into daily lives, such as mobile phones, tablet computers, laptops, etc. Specification requirements of lens applied in those electronic devices are also highly increased.

In the prior art, the wafer lenses made of glass materials are generally produced by a glass processing mold through thermoforming. When the glass processing mold is enclosed, cavities with a preset shape will be encircled inside the glass processing mold, the cavities can help shape the heated glass substrate, and then the glass substrate is cooled to form glass products with a preset shape. The glass product will be directly attached to a forming surface to cool due to gravity and sticking.

However, the processing of the glass processing mold in the prior art has the following problems:

Firstly, at the last step of the molding process, the glass product 301 may be stuck together with the feature points 303 (namely the site where the lens is formed) of the mold 302, or it may be stuck together with the mold at a random point 304 (namely any point of the forming surface) to form a point contact, as shown in FIG. 5, where an arrow represents the shrinkage direction of the glass product. Contacting area of the glass product contacting with the mold tends to cool faster for the mold is cooled, and it may cause an uneven shrinkage across the glass product, leading to a deformation of the glass product, as shown in FIG. 6.

Secondly, in the forming process, the glass product shows a strong adhesion to the mold surface. Although adhesion will gradually reduce during the cooling process, it takes a long time for the glass product to completely cool that leads to an auto release, thus increasing the cost. Besides, if the adhesion is too strong, the glass product tends to crack.

Thirdly, the mold 302 with large angle feature will increase the risk of breakage of the glass product 301 during the process of shrinkage, because the shrinkage rate of the glass product 301 in the cooling process is greater than that of the mold 302, and the large angle feature of the mold 302 will prevent the glass product 301 from freely shrinking in the horizontal direction. The larger the diameter of the glass product 301, the greater the impact, as shown in FIG. 7, where an arrow indicates the shrinkage direction of the glass product and the mold; when the strain caused by the shrinkage difference between the mold and the glass product 301 goes beyond the strain that the glass product can sustain, the glass product 301 will crack, as shown in FIG. 8.

Therefore, it is necessary to provide an improved mold to solve the above problems.

### SUMMARY

One of the objectives of the disclosure is to provide a glass product forming mold, so as to solve the problem that the product quality is adversely affected by the existing glass processing molds.

One of the objectives of the disclosure is realized by adopting the following technical scheme:

Provided is a glass product forming mold for forming a glass product, comprising a mold body and a plurality of sliding blocks slidably mounted on the mold body and facing the glass product; the plurality of sliding blocks each comprises a first inclined surface; the plurality of sliding blocks are configured to be inserted between the glass product and the mold body through the plurality of the first inclined surfaces to separate the glass product and the mold body.

As an improvement, each first inclined surface is planar.

As an improvement, the glass product forming mold comprises four sliding blocks, and the four sliding blocks equidistantly surround the mold body, a distance between each two neighbouring sliding blocks is the same.

The disclosure also provides a glass product forming device, comprising a driving mechanism and the aforesaid glass product forming mold; the driving mechanism is configured to drive the plurality of sliding blocks to slide towards or away from a central axis of the mold body.

Still, the disclosure also provides a method of processing a glass product, comprising:

providing a glass substrate and the aforesaid glass forming device;

placing the glass substrate in the glass product forming mold and shaping the glass substrate into a glass product;

driving the plurality of sliding blocks to slide towards the central axis of the mold body by the driving mechanism when a temperature of the glass product drops in a glass transition temperature and prior to complete cooling of the glass product, to enable the plurality of sliding blocks to be inserted between the glass product and the mold body via the first inclined surface to separate the glass product from the mold body; and

cooling the glass product.

As an improvement, after the step of cooling the glass product, the method of processing the glass product further comprises a step of removing the glass product, and driving, by the driving mechanism, the plurality of sliding blocks to slide away from the central axis of the mold body.

In this disclosure, a plurality of sliding blocks slidably is disposed on the mold body and faces the glass product, when the glass product is formed and before it is completely cooled, the slide blocks can be driven to slide with respect to the mold body, so that the slide blocks can be inserted between the mold body and the glass product through a inclined surface to separate the glass product and the mold body; the glass product does not contact the mold body, avoiding the deformation of raw glass products resulting from the uneven heat distribution, uneven shrinkage or excessive adhesion due to the influence of the mold body, ensuring the quality of the glass product, and the glass products will not be interfered by the mold body during the process of cooling shrinkage, which reduces the risk of cracking of the glass product. Besides, by separating the glass products from the mold body and then cooling, the cooling speed of the glass products can be accelerated, and the production cycle is shortened.

### BRIEF DESCRIPTION OF THE DRAWINGS

FIG. 1 is a schematic diagram of one exemplary embodiment of a glass product forming mold;

FIG. 2 is a schematic diagram of one exemplary embodiment of a plurality of sliding blocks separating a glass product from a mold body;

FIG. 3 is a sectional view taken along line A-A of FIG. 2;

FIG. 4 is an enlarged view of a circled portion B of FIG. 3;

FIG. 5 is a schematic diagram of a glass product and a mold in a prior art;

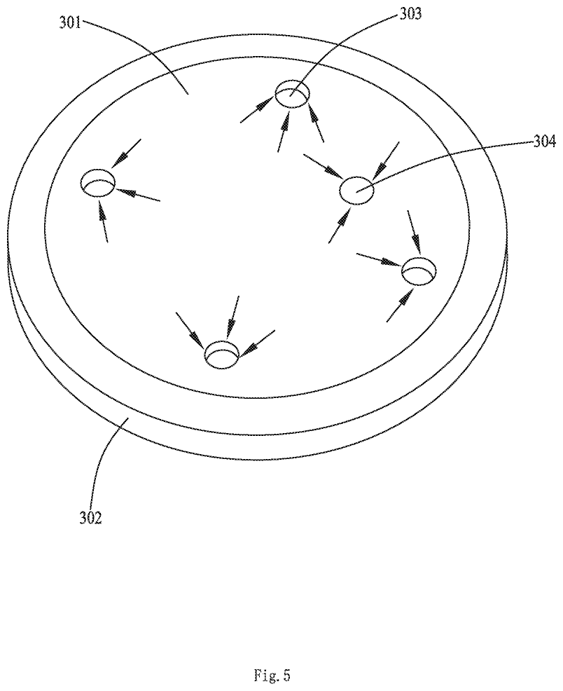

FIG. 6 is a diagrammatic view of the deformation of the glass product due to uneven heat distribution of FIG. 5;

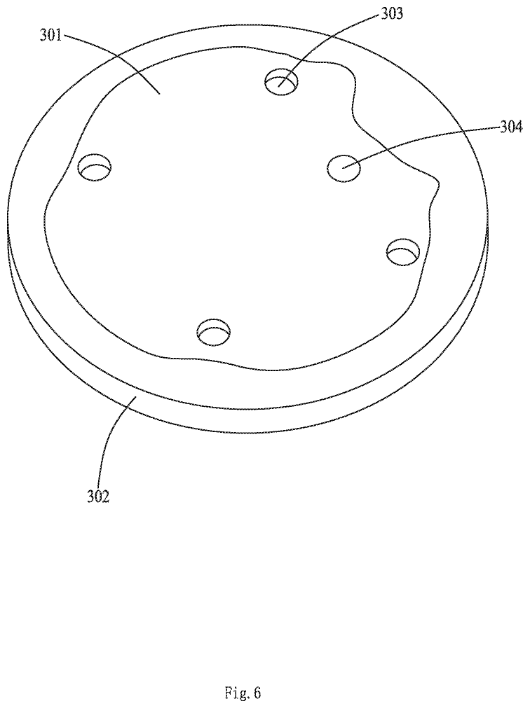

FIG. 7 is a diagrammatic view of the glass product and the mold being contracted of FIG. 5; and

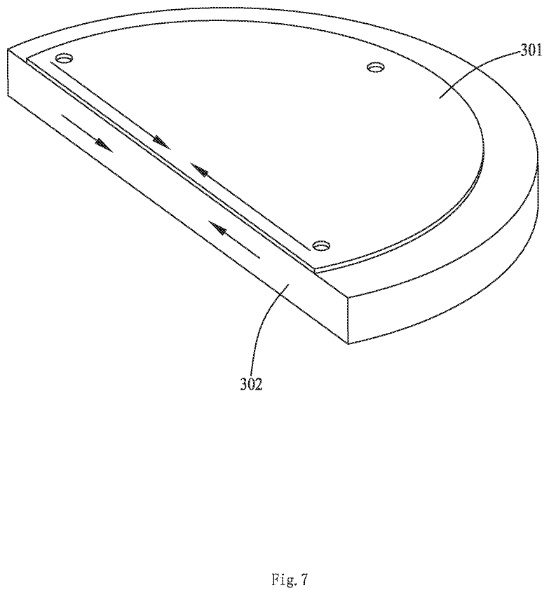

FIG. 8 is a diagrammatic view of the broken glass product due to contracted difference of FIG. 5.

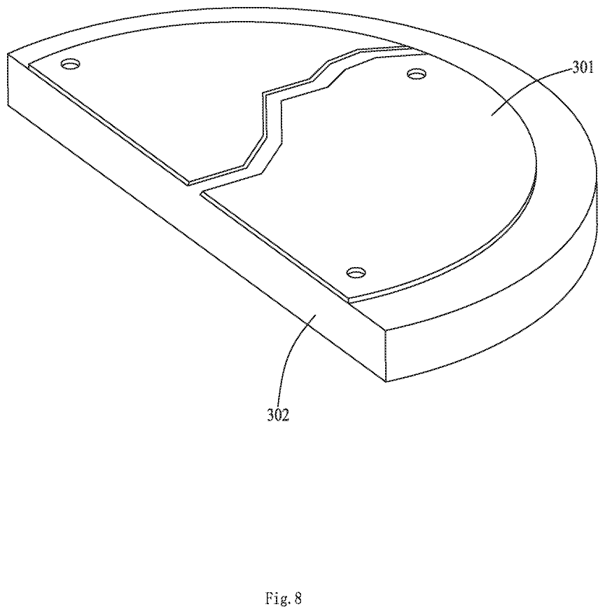

In the drawings, the following reference numbers are used: 100. Glass product forming mold; 10. Mold body; 20. Sliding block; 200. Glass product; 21. First inclined surface; 201. Second inclined surface.

### DETAILED DESCRIPTION OF THE PREFERRED EMBODIMENTS

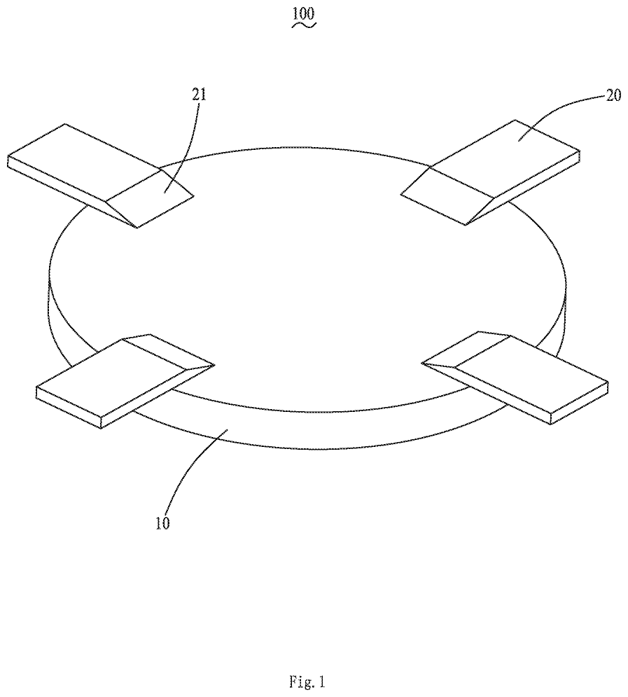

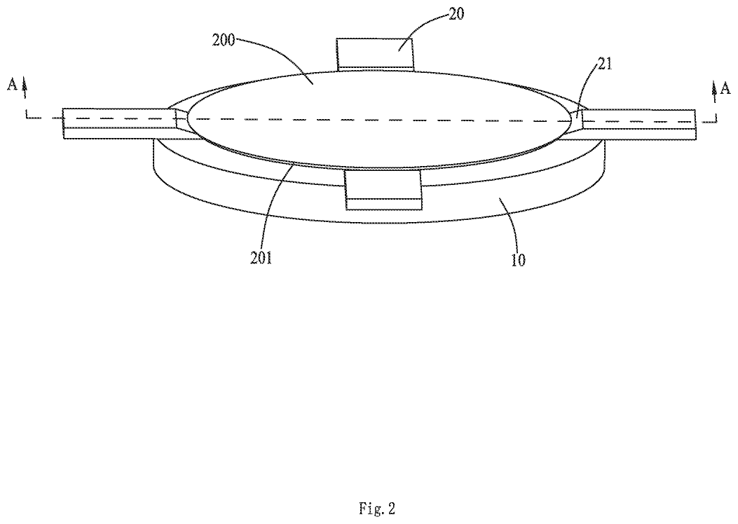

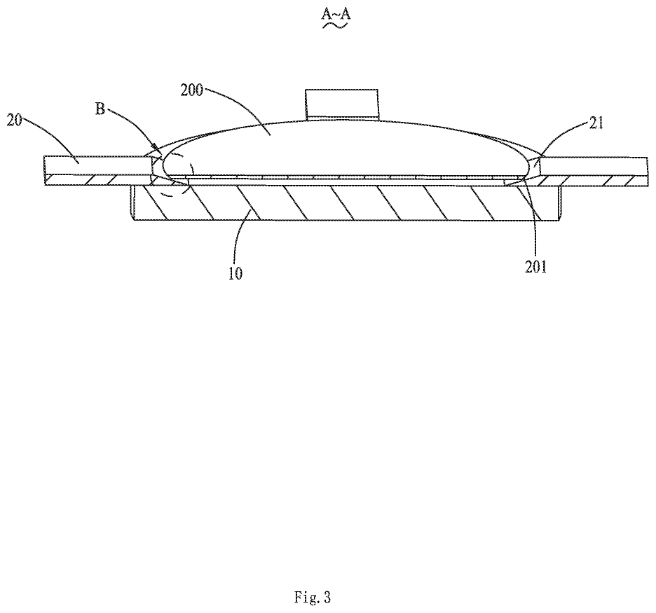

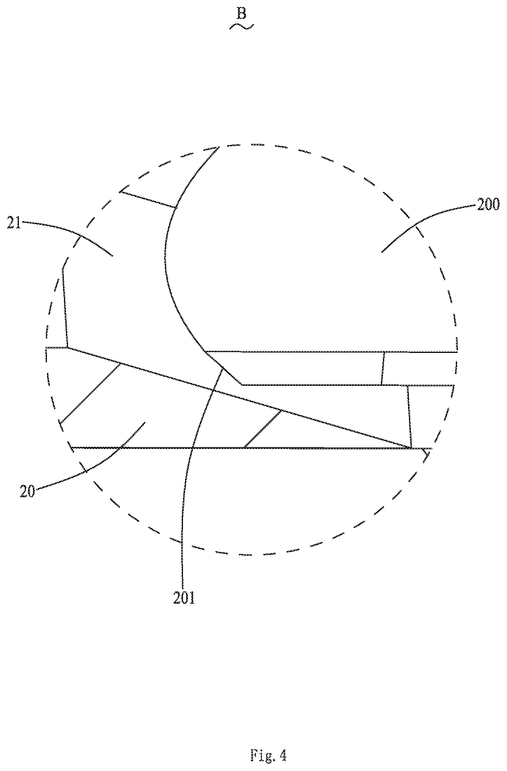

The disclosure is described in detail below in combination with FIGS. 1 to 4.

It should be noted that all directional indications (such as up, down, left, right, front, rear, inside, outside, top, bottom, . . . ) in the embodiment of the disclosure are only used to explain the relative position relationship among the components under a certain attitude (as shown in the attached figures), etc. if the specific attitude changes, the directivity indication will change accordingly.

It should also be noted that when a component is called “fixed to” or “disposed on” another component, the component can directly interacts with another component or there may be an intermediate component at the same time. When a component is referred to as “connecting to” another component, it can be directly connected to another component or there may be an intermediate component at the same time.

As shown in FIGS. 1-4, the disclosure provides a glass forming device comprising a driving mechanism and a glass product forming mold 100. The glass product forming mold 100 comprises a mold body 10 and a plurality of sliding blocks 20 slidably mounted on the mold body 10, the driving mechanism is configured to drive the plurality of sliding blocks 20 to radially slide with respect to the mold body 10. Each of the plurality of sliding blocks 20 comprises a first inclined surface 21, the plurality of sliding blocks 20 are configured to be inserted between the glass product 200 and the mold body 10 through the plurality of the first inclined surfaces 21 to separate the glass product 200 from the mold body 10.

Preferably, a second inclined surface 201 facing the mold body 10 is disposed at an edge of the glass product 200. The second inclined surface 201 facilitates the plurality of sliding blocks 20 to be inserted between the glass product 200 and the mold body 10. When the glass product 200 is formed, the driving mechanism drives the plurality of sliding blocks 20 to radially slide with respect to the mold body 10, and the plurality of sliding blocks 20 is inserted between the glass product 200 and the mold body 10 via the plurality of first inclined surfaces 21 and the second inclined surface 201 to separate the glass product 200 from the mold body 10.

In at least one exemplary embodiment, the driving mechanism is configured to drive the plurality of sliding blocks 20 to slide towards or away from a central axis of the mold body 10, that is, to slide towards or away from the glass product 200. When the glass product 200 is formed, the driving mechanism is controlled to drive the plurality of sliding blocks 20 to slide towards the glass product 200, so that the plurality of sliding blocks 20 can be inserted between the glass product 200 and the mold body 10 via the plurality of first inclined surfaces 21. With the sliding of the slide blocks 20, the slide blocks 20 tend to lift the glass product 200 to separate the glass product 200 from the mold body 10.

In at least one exemplary embodiment, because the glass product 200 does not contact the mold body 10, a deformation of the glass product 200 due to the uneven heat distribution or excessive adhesion caused by the contact between the glass product 200 and the mold body 10 during the cooling process is avoided, and the quality of the glass product 200 is assured. Besides, because the glass product 200 does not contact the mold body 10, the cooling speed of the glass product 200 is accelerated, which can shorten the production cycle of the glass product 200, and the glass product 200 will not be hindered by the mold body 10 during the process of cooling shrinkage, so as to avoid the risk of cracking of the glass product 200 due to the different thermal expansion coefficients of the mold body 10 and the glass product 200. The thermal expansion coefficient refers to the expansion and contraction of an object due to the change of temperature. The larger the thermal expansion coefficient is, the greater the shrinkage degree will be.

Specifically, in one exemplary embodiment, the shape of the glass product 200 is approximately a circular table, and the shape of the mold body 10 is cylindrical.

Preferably, each first inclined surface 21 is planar, which is easy to shape.

Understandably, the first inclined surface 21 is not limited to a plane, for example, it can also be a surface or a combination of a plane and a surface.

Preferably, in one exemplary embodiment, the glass product forming mold 100 comprises four sliding blocks 20 equidistantly surrounding the mold body 10, and a distance between each two neighbouring sliding blocks 20 is the same.

Four equidistant sliding blocks 20 can lift each part of the glass product 200 simultaneously, avoiding the problem that one end of the glass product 200 is disconnected from the mold body 10, while the other end is still in contact with the mold body 10. Understandably, four sliding blocks 20 equidistantly and separately surrounding the mold body 10 make the glass product 200 evenly stressed during the lifting process of the glass product 200, so as to prevent the glass product 200 from cracking due to uneven stress.

Understandably, the number of the sliding blocks 20 is not limited to four, for example, two, three or more other numbers are also possible.

The disclosure also provides a method of processing a glass product 200, the method comprising:

providing the aforesaid glass product forming mold 100 and a glass substrate;

placing the glass substrate in the glass product forming mold 100 to form a glass product 200 at a temperature higher than a glass transition temperature of the glass product 200;

driving the plurality of sliding blocks 20 to slide towards the central axis of the mold body 10 by the driving mechanism when a temperature of the glass product 200 drops in the glass transition temperature and prior to complete cooling of the glass product 200, to enable the plurality of sliding blocks 20 to be inserted between the glass product 200 and the mold body 10 via the plurality of first inclined surfaces 21 and slides to lift the glass product 200, so as to separate the glass product 200 from the mold body 10; and cooling the glass product 200;

removing the glass product 200 after the glass product 200 is cooled, and driving the sliding blocks 20 to slide away from the central axis of the mold body 10 until the sliding blocks 20 return to the original position.

The glass transition temperature refers to a temperature at which the glass can transform from a high elastic state to a glass state or from a glass state to a high elastic state. The glass product 200 is in a high elastic state in the environment higher than the glass transition temperature. At this time, the glass product is easily deformed in the presence of an external force; the glass product 200 is in a glass state in the environment lower than the glass transition temperature. At this time, the glass product has certain rigidity, it is difficult to deform even in the presence of an external force. Therefore, only when the temperature of the glass product 200 drops below the glass transition temperature, can the sliding blocks 20 be driven to slide, so as to avoid the deformation of the glass product 200 caused by the random sliding of the sliding blocks 20. Besides, the glass product 200 is disconnected from the mold body 10 before it is completely cooled, which can eliminate the influence of the mold body 10 on the later cooling of the glass product 200, and can accelerate the cooling speed of the glass product 200 and shorten the production cycle.

The above embodiments are only the preferred embodiments of the disclosure, and do not limit the scope of the disclosure. A person skilled in the art may make various other corresponding changes and deformations based on the described technical solutions and concepts. And all such changes and deformations shall also fall within the scope of the present disclosure.

1. A glass product forming mold for forming a glass product, comprising:
a mold body; and
a plurality of sliding blocks slidably mounted on the mold body and facing the glass product;
wherein each of the plurality of sliding blocks comprises a first inclined surface; the plurality of sliding blocks are configured to be inserted between the glass product and the mold body through the plurality of the first inclined surfaces to separate the glass product from the mold body.

2. The glass product forming mold of claim 1, wherein each first inclined surface is planar.

3. The glass product forming mold of claim 1, wherein the glass product forming mold comprises four sliding blocks, and the four sliding blocks equidistantly surround the mold body, a distance between each two neighbouring sliding blocks is the same.

4. A glass product forming device, comprising:
a glass product forming mold of claim 1; and
a driving mechanism;
wherein the driving mechanism is configured to drive the plurality of sliding blocks to slide towards or away from a central axis of the mold body.

5. The glass product forming device of claim 4, wherein each first inclined surface is planar.

6. The glass product forming device of claim 4, wherein the glass product forming mold comprises four sliding blocks, and the four sliding blocks equidistantly surround the mold body, a distance between each two neighbouring sliding blocks is the same.

7. A method of processing a glass product, comprising:
providing a glass forming device of claim 4 and a glass substrate;
placing the glass substrate in the glass product forming mold to form a glass product;
driving the plurality of sliding blocks to slide towards the central axis of the mold body by the driving mechanism when a temperature of the glass product drops in a glass transition temperature and prior to complete cooling of the glass product, to enable the plurality of sliding blocks to be inserted between the glass product and the mold body through the plurality of the first inclined surfaces to separate the glass product from the mold body; and
cooling the glass product.

8. The method of claim 7, wherein after the step of cooling the glass product, the method of processing the glass product further comprises a step of removing the glass product, and driving, by the driving mechanism, the plurality of sliding blocks to slide away from the central axis of the mold body.

9. The method of claim 7, wherein each first inclined surface is planar.

10. The method of claim 9, wherein after the step of cooling the glass product, the method of processing the glass product further comprises a step of removing the glass product, and driving, by the driving mechanism, the plurality of sliding blocks to slide away from the central axis of the mold body.

11. The method of claim 7, wherein the glass product forming mold comprises four sliding blocks, and the four sliding blocks equidistantly surround the mold body, a distance between each two neighbouring sliding blocks is the same.

12. The method of claim 11, wherein after the step of cooling the glass product, the method of processing the glass product further comprises a step of removing the glass product, and driving, by the driving mechanism, the plurality of sliding blocks to slide away from the central axis of the mold body.
